(19) United States
(12) Patent Application Publication
(10) Pub. No.: US 2025/0265060 A1
(43) Pub. Date: Aug. 21, 2025

(54) METHOD AND APPARATUS FOR COMPUTER CODE ANALYSIS USING GENERATIVE AI SYSTEM

(71) Applicant: PRICEWATERHOUSECOOPERS LLP, Toronto (CA)

(72) Inventors: Vik PANT, Toronto (CA); Bahar SATELI, Montreal (CA)

(21) Appl. No.: 19/058,455

(22) Filed: Feb. 20, 2025

(30) Foreign Application Priority Data
Feb. 20, 2024 (CA) 3229642

(51) Int. Cl. G06F 8/51; G06F 8/34

(52) U.S. Cl. CPC G06F 8/51; G06F 8/34

(57) ABSTRACT

A computer system comprising one or computers and one or more data storage devices storing instructions, which when executed by the one or more computers implements a computer code conversion utility, comprising: Graphical User Interface (GUI) manager; a prompt manager; a Generative AI service interface; the GUI manager being configured to implement a GUI for receiving an input, including a first computer code; the prompt manager configured to generate in response to the input a first Generative AI service prompt with instructions to derive from the first computer code a relational representation of the first computer code; the prompt manager configured to generate a second Generative AI service prompt conveying the relational representation or a derivative form of the relational representation and the first computer code with instructions to convert the first computer code to a second computer code where the second computer code retains an overall functionality of the first computer code; the Generative AI service interface configured to receive the second computer code.

### FIELD OF THE INVENTION

The present invention pertains to the domain of automated computer code generation and management, through the application of Generative Artificial Intelligence (AI) systems. Specifically, the invention introduces a novel method, and a system designed to analyze and optionally enhance computer code. This is achieved by employing a Generative AI framework capable of analyzing and optionally updating a legacy codebase within the same programming language or, alternatively, converting the legacy code into a different, potentially more efficient or modern programming language. This optional process of enhancing the legacy code not only revitalizes aged software systems, making them compatible with contemporary computing environments and standards but also ensures that the upgraded or transformed code maintains its original functionality while potentially introducing improvements in performance, security, and maintainability.

### BACKGROUND OF THE INVENTION

Numerous enterprises continue to rely on legacy computer software systems, primarily due to the exorbitant costs associated with conducting a comprehensive overhaul of such systems. Often, these legacy systems are developed using programming languages that have since become obsolete and are lacking sufficient documentation. This absence of detailed documentation impedes the ability of software developers to execute periodic updates and optimizations effectively. Consequently, developers are compelled to dedicate a substantial portion of their time to meticulously analyzing the legacy code in order to decipher its architectural design and operational functionalities.

For extensive and complex software applications, the intricacies involved in this preliminary analysis phase are considerable. The task encompasses a thorough examination of the codebase to identify and understand the original design patterns, dependencies, and algorithmic implementations. This process is critical for ensuring any future modifications or upgrades do not compromise the software's integrity or functionality. However, the labor-intensive nature of this task and the specialized expertise required make it a cost-intensive endeavor for organizations.

Upon successful completion of the code analysis, transitioning to the actual code upgrade phase introduces a new set of challenges. These challenges include ensuring compatibility with modern computing environments, integrating new functionalities without disrupting existing operations, and optimizing performance. Additionally, there is the imperative of addressing any security vulnerabilities inherent in the old code to meet current cybersecurity standards. Each of these steps requires careful planning, a deep understanding of both old and new programming paradigms, and a strategic approach to implementing changes in a manner that minimizes downtime and operational disruption. This multifaceted process underscores the complexity and resource-intensive nature of upgrading legacy computer software systems in today's rapidly evolving technological landscape.

Accordingly, there is a need in the industry to provide an automated process to maintain and/or update computer code using a Generative AI system.

### SUMMARY OF THE INVENTION

In accordance with one embodiment of the present disclosure, the invention provides a method and system for the analysis of program code to yield a relational representation thereof. This high-level representation exposes relationships within the code, thereby facilitating the user's comprehension of the code's structure. This functionality proves particularly advantageous in scenarios where the code lacks adequate documentation or instances where the user was not involved in the code's initial development, thus possessing no prior knowledge or insights into its creation.

In a particular embodiment, the method for analyzing computer code is performed through the use of a Generative Artificial Intelligence (AI) system. This method entails the processing of the computer code by the Generative AI system, which is configured with machine-executable instructions specifically designed to extract characterizing elements from the computer code. These characterizing elements convey relationships between different components of the computer code, such as, for example, semantic associations. For instance, the characterizing elements can provide a relational representation of the computer code. This relational representation is helpful in delineating the structural and/or functional relationships within the code, thereby facilitating the understanding of the code's architecture and/or operational dynamics.

In the context of computer code, semantic associations refer to the meaningful relationships and connections between various components or elements within the codebase. These associations encompass the dependencies, interactions, and functional correlations that exist among different modules, functions, variables, and data structures. These associations go beyond syntax, focusing on how elements are related based on their intended purpose, behavior and the concepts they represent within a program. Examples of semantic associations include:

### 1. Functional Relationships:

a. Functions or methods often have semantic associations based on their roles. For example, functions named calculateCost and calculateDiscount may be associated because they both relate to calculations in financial contexts.
b. In object-oriented programming, methods within a class are semantically associated because they contribute to the behavior of the class. For instance, methods like open ( ) close ( ) and read ( ) in a File class are associated with file operations.

### 2. Data Flow and Variable Usage:

a. Variables often carry semantic associations based on the data they represent. For instance, variables like username, userID and userEmail are semantically related because they all describe different aspects of User entity.
b. Semantic associations in data flow help with tracing how data is processed within a program. For example, in a data pipeline, steps like dataCleaning, dataTransformation and dataModeling are semantically connected as stages of data preparation.

### 3. Type and Structure Associations:

a. Structuring data types (e.g. arrays, lists, dictionaries, objects) can be associated based on their semantic roles. For example, a Student class might have attributes like name, age and grade, semantically associated as characteristics of student.
b. Classes and structures often reflect real world associations. In a Library application, classes such as book, author, and publisher are semantically linked because they represent entities in the domain of literature.

### 4. Module and Component Relationships.

a. Code modules and components are typically associated by the functionality they provide. For example, a DatabaseHandler module, an APIHandler module, and a DataProcessor module may be semantically associated in a data-driven application as they contribute to different stages of data management.
b. Microservices or modules in software architecture often reflect semantic associations, where each service has a specific purpose (e.g., AuthService, UserService), creating a cohesive system with related yet independent components.

### 5. Dependency and Contextual Associations.

a. Dependencies between libraries or functions establish semantic associations. For instance, if a function relies on an encryption library, it's likely performing some security related task.
b. Contextual associations exist when one piece of code sets up conditions for another period for example, establishing a database connection (connectToDB( )) is semantically associated with operations like fetchData( ) or insertRecord( ) that rely on that connection.

In a detailed example, the machine instructions that direct the Generative AI entity to output characterizing elements from the first computer code, which are commonly referred to as a “prompt” are configured to structure the output of the Generative AI entity as a graph representation using nodes for entities of the first computer code and edges for relationships.

Graphs are foundational tool for modeling relationships between objects in computer science. A graph comprises two primary components: nodes (also known as vertices) and edges. Nodes are the basic units of a graph. They can represent various entities depending on the application. For instance, nodes in the context of the first computer code can represent functional elements of the first computer code, such as functions, variables, classes, methods, modules and libraries, among others. The nodes can have properties associated with them such as an identifier which is a unique label that distinguishes each node from other nodes in the graph, attributes which convey additional information associated with the node and which characterizes the element of the first computer code that is represented by the node, and also a degree, which identifies the number of edges connected to the node indicating its level of connectivity, among other possible properties.

Edges are the connections between nodes and represent the relationships or interactions between them. In an undirected graph, edges have no orientation, meaning the connection is bidirectional. However, in a directed graph, edges have a direction, indicating a one-way relationship from one node to another.

Edges can have several properties, such as weight, which is a value representing the cost, distance, or strength of the connection between nodes, a type which is an indicator of the nature of the relationship, which can be classified into categories, and for directed graphs, the orientation of the edge, indicating the start and end nodes.

Graphs can be represented in various ways, including adjacency lists, adjacency matrices, and edge lists, among possible other representations. Each representation method has its advantages and is chosen based on the specific requirements of the application.

An adjacency list represents a graph by listing each node and its adjacent nodes. This method is efficient for sparse graphs, where the number of edges is relatively low compared to the number of nodes.

An adjacency matrix is a two-dimensional array in which each cell indicates the presence or absence (and sometimes the weight) of an edge between nodes. This method is useful for dense graphs, where the number of edges is high.

An edge list represents a graph by listing all edges along with the nodes they connect. This method provides a straightforward way to store and traverse edges.

The machine instructions that configure the Generative AI entity to generate relational representation of the computer code, known (the prompt) can explicitly state the different categories for these code elements to be used for the relational representation. In this way, the Generative AI system processes the code to identify and place its elements into these designated categories, while also discerning the semantic relationships between these classified elements.

The relational output generated by the Generative AI system thus offers a streamlined and accessible platform for subsequent review, modification, and enhancement by a software programmer. This approach significantly simplifies the programmer's task of comprehending the complexities embedded within the first computer code by providing a relational representation that is inherently more intelligible. Optionally, it grants the software programmer the flexibility to implement modifications and enhancements directly to the relational version and have visibility on the potential impact of the change. This capability obviates the immediate necessity for the programmer to engage directly with the intricate details of the first computer code. Such a procedural step not only enhances the efficiency of the code modification process but also potentially reduces the time and technical barriers typically associated with understanding and refining complex computer code structures in their native formats.

In a variant, the method further includes enhancing the computer code by processing the computer code along with a relational representation thereof by a Generative AI system. The relational representation can be the same relational representation generated previously or a derivative thereof, such a version that has been modified by a software programmer. The Generative AI system used for enhancing the computer code can be the same as the Generative AI system used for generating the relational representation of the computer code, but it can be different, namely it uses a different Large Language Model, this is tailored to make enhancements to computer code. In a specific example, the enhancement to the computer code is carried out while preserving the functionality of the computer code, in other words the original and the enhanced versions perform the same core tasks and achieve the same intended outcomes.

In a specific and non-limiting example of implementation, the code enhancement process includes a conversion of the computer code from a first programming language to a second programming language, while preserving the functionality of the original code.

In a specific and non-limiting example of implementation, the method is thus a multiple pass process, such as two or more passes process, where at least the first pass processes a first computer code to extract from the computer code characterizing information. In a subsequent phase, following the generation of the relational representation, said relational version or a derivative thereof is then inputted into a Generative Artificial Intelligence (AI) system along with the first computer code in its programming language. This system may either be identical to the Generative AI system utilized in the first phase or an alternative Generative AI system, along with specific machine instructions to direct the transformation of the first computer code into a second computer code in a different programming language than the first computer code.

The output of this second phase is the production of the second computer code, which represents an evolved or enhanced state of the first computer code.

One advantage of the disclosed method is the use of a relational representation of the first computer code in combination with the first code itself, to generate its enhancement through Generative AI processing. The relational representation provided to the Generative Artificial Intelligence (AI) system, along with the first computer code, serves as a guide that aids the enhancement process at a relational, particularly semantic level. This approach is believed to improve the accuracy of the enhancement, in particular the preservation of the functionality of the original computer code into the enhanced version.

The Generative AI system, which is used for the second pass process to enhance the first computer code may be the same Generative AI system utilized in the first pass to generate the relational representation or an alternative Generative AI system.

The output of this second pass is the production of a second computer code, which represents an evolved or enhanced state of the original code. This process, by leveraging the relational representation, increases the probability that the final computer code will retain the original functionality of the first computer code.

In a second embodiment, the invention provides a method, system and related technology elements for estimating a characteristic of an output of a Generative AI system. From a practical perspective, such estimation provides the end-user or administrator of the Generative AI system with insight into what the Generative AI system is likely to produce given a certain input, which can be used for various purposes. In one example, the estimated characteristic may be output token volume, such as token count, which is the size of the output. Since token count is typically linked to the cost usage of the Generative AI system, such estimation may serve as an indication to the end-user or to the administrator of the cost for the process to elicit an output from the Generative AI system, from a known input. This is useful in applications where there are cost constraints for using the Generative AI system and it would be useful to know, before the Generative AI process is preformed, whether any cost threshold for system usage will be exceeded.

Additionally, the disclosed method may incorporate mechanisms for dynamically adjusting the input parameters to align the predicted output characteristics with the desired cost parameters. Such dynamic adjustment mechanisms may include the selection of a specific large language model (LLM) or, more broadly, a Generative AI system from a set of available Generative AI systems, each with distinct operational characteristics, particularly with respect to usage cost.

Consequently, by determining the overall token volume output, it is feasible to select the most cost-effective Generative AI system from the set to service the request. This selection process involves evaluating the cost implications of each system based on the predicted token count, thus enabling the selection of an appropriate Generative AI system that meets cost constraints. Another characteristic that can be estimated for the Generative AI system is the output complexity. While the token count inherently serves as an indicator of the output's complexity, as a higher number of tokens generally implies a more intricate output, additional parameters may be incorporated to evaluate output complexity with greater precision.

Output complexity is particularly relevant in scenarios where the outputs generated by the Generative AI system require further processing, whether manually by a human operator or through an automated system. In such contexts, output complexity indicates the subsequent processing load. For certain applications, an excessive increase in downstream processing load can make the Generative AI system's output impractical for use. This is especially true in computer code enhancement applications, where the target software code generated by the Generative AI system requires evaluation and testing to ensure it complies with functional requirements. As the length of the software code output by the Generative AI system increases, the testing requirements and time to complete them also increase, potentially rendering the entire process impractical.

Therefore, by monitoring and adjusting for output complexity, it becomes feasible to maintain the balance between the Generative AI system's performance and the practical usability of its outputs. This approach ensures that the end products remain within manageable complexity thresholds, thereby facilitating efficient downstream processing and preserving overall system functionality and utility.

As embodied and broadly described herein the invention thus provides a computer system comprising one or more computers and one or more data storage devices storing instructions, which when executed by the one or more computers implements a computer code conversion utility, comprising:
a) a Graphical User Interface (GUI) manager configured to implement a GUI;
b) a prompt manager;
c) a Generative AI service interface;
d) the GUI manager being configured to receive an input via the GUI, including a first computer code;
e) the prompt manager being responsive to the input to generate a first prompt to request a Generative AI service via the Generative AI service interface to derive from the first computer code a relational representation of the first computer code;
the Generative AI service interface configured to receive the relational representation;
f) the GUI manager configured to implement on the GUI one or more characteristics of the relational representation.

In a specific and non-limiting example of implementation, the relational representation is in the form of a graph, comprising nodes and edges.

In a specific and non-limiting example of implementation, the GUI comprises controls to configure a processing of the first computer code to generate the relational representation.

In a specific and non-limiting example of implementation, the relational representation captures semantic associations between different components of the first computer code.

In a specific and non-limiting example of implementation, the different components of the first computer code include either one of the following: functions, variables, classes, methods, modules and libraries.

In a specific and non-limiting example of implementation, the GUI manager being configured to implement tools on the GUI allowing a user to modify the relational representation and generate a derivative form of the relational representation.

In a specific and non-limiting example of implementation, the controls to configure the processing of the first code include a control to select a Generative AI system to perform the generation of the relational representation among a plurality of Generative AI systems.

In a specific and non-limiting example of implementation, the control to configure the processing of the first code to generate the relational representation is configured to allow a user to select components of the first code to be included in the relational representation.

As embodied and broadly described herein, the invention further provides a computer system comprising one or computers and one or more data storage devices storing instructions, which when executed by the one or more computers implements a computer code conversion utility, comprising:
a) a Graphical User Interface (GUI) manager;
b) a prompt manager;
c) a Generative AI service interface;
d) the GUI manager being configured to implement a GUI for receiving an input, including a first computer code;
e) the prompt manager configured to generate in response to the input a first Generative AI service prompt with instructions for deriving from the first computer code a relational representation of the first computer code;
f) the prompt manager configured to generate a second General AI service prompt conveying the relational representation or a derivative form of the relational representation and the first computer code with instructions to convert the first computer code to a second computer code where the second computer code retains an overall functionality of the first computer code;
g) receive via the Generative AI service interface the second computer code.

In a specific non-limiting example of implementation, the first computer code is in a first language and the second computer code is in a second language different from the first language.

In a specific and non-limiting example of implementation, the relational representation is in the form of a graph, comprising nodes and edges.

In a specific and non-limiting example of implementation the GUI manager is configured to implement on the GUI comprising controls to configure a processing of the first computer code to generate the second computer code.

In a specific and non-limiting example of implementation the relational representation captures semantic associations between different components of the first code.

In a specific and non-limiting example of implementation the different components of the first code include either one of the following: functions, variables, classes, methods, modules and libraries.

In a specific and non-limiting example of implementation the GUI manager is configured to display on the GUI the relational representation.

In a specific and non-limiting example of implementation the GUI manager is configured to implement tools allowing a user to modify the relational representation and generate a derivative form of the relational representation.

In a specific and non-limiting example of implementation the controls to configure the processing of the first code include a control to configure the processing of the first code to generate the relational representation.

In a specific and non-limiting example of implementation, the control to configure the processing of the first code to generate the relational representation is configured to allow a user to select components of the first code to be included in the relational representation.

In a specific and non-limiting example of implementation the controls to configure the processing of the first code include a control to specify the language of the first code.

In a specific and non-limiting example of implementation the controls to configure the processing of the first code include a control to specify the language of the second code.

In a specific and non-limiting example of implementation the prompt manager being responsive to user input at the control to specify the language of the second code to generate instructions in the second prompt directing the Generative AI service to output the second code in the specified language.

In a specific and non-limiting example of implementation the prompt manager is response to user input at the control to specify the language of the first code to generate instructions to the Generative AI service to indicate the specified language of the first code.

In a specific and non-limiting example of implementation the GUI manager is responsive to the second computer code received via the Generative AI service interface to display the second computer code via the GUI.

As embodied and broadly described herein, the invention further provides a computer system comprising one or computers and one or more data storage devices storing instructions, which when executed by the one or more computers implements a computer code management utility, comprising:
a. a Graphical User Interface (GUI) manager;
b. a prompt manager;
c. a Generative AI service interface;
d. the GUI manager being configured to implement a GUI comprising a first task selection control and a second task selection control, wherein the first task includes generation of a relational representation of a first computer code, wherein the second task includes conversion of the first computer code to a second computer code, where the first computer code and the second computer code have an overall similar functionality, wherein the first task selection control is configured for receiving user input conveying an instruction for generating the relational representation, wherein the second task selection control is configured for receiving user input conveying an instruction for converting the first computer code to the second computer code;
e. the prompt manager being responsive to the user input at the first task selection control to generate a first Generative AI service prompt with instructions to derive from the first computer code a relational representation of the first computer code;
f. the prompt manager being responsive to user input at the second task selection control to generate a Generative AI service prompt to convert the first computer code to the second computer code where the second computer code retains an overall functionality of the first computer code, using as a factor the relational representation or a derivative form of the relational representation.

In a specific and non-limiting example of implementation, the first computer code is in a first language and the second computer code is in a second language different from the first language.

In a specific and non-limiting example of implementation, the relational representation is in the form of a graph, comprising nodes and edges.

In a specific and non-limiting example of implementation, the relational representation captures semantic associations between different components of the first code.

In a specific and non-limiting example of implementation, the relational representation of the original code can be leveraged to generate human-readable artifacts that can externalize the inherent complexities and interdependencies within the code, such as business rules, data lineage, and requirements specifications.

In a specific and non-limiting example of implementation, the different components of the first code include either one of the following: functions, variables, classes, methods, modules and libraries.

In a specific and non-limiting example of implementation, the GUI manager is configured to display on the GUI the relational representation.

In a specific and non-limiting example of implementation, the GUI manager being configured to implement tools allowing a user to modify the relational representation and generate a derivative form of the relational representation.

### BRIEF DESCRIPTION OF THE DRAWINGS

FIG. 1: Block diagram of a computer network architecture for deploying an LLM that services users.

FIG. 2: Block diagram of a computer code conversion utility using the Generative AI system to perform software code conversion.

FIG. 3: Detailed block diagram of a software stack executed by cloud servers to provide LLM services to end users.

FIG. 4: Flow chart illustrating the typical interaction and data flow during the operation of the code analysis, comprehension, and conversion utility shown in FIG. 2.

FIG. 5: Graphical User Interface illustration, for providing inputs to the code analysis, comprehension, and conversion utility of FIG. 2.

FIG. 6: Graphical User Interface illustration similar to FIG. 5, showing additional inputs for the code analysis, comprehension, and conversion utility of FIG. 2.

FIG. 7: Graphical User Interface illustration, showing a side-by-side comparison of original source code and converted code.

FIG. 8: Block diagram showing a variant of the code conversion utility described in FIG. 2.

FIG. 9: Graphical User Interface illustration, showing an example of results from code analysis and comprehension.

FIG. 10: Graphical User Interface illustration, showing an example of parsing results of code analysis and comprehension.

FIG. 11: Graphical User Interface illustration, showing an example of complexity analysis results.

FIG. 12: Graphical User Interface illustration, showing an example of data schemas resulting from code analysis and comprehension.

FIG. 13: Graphical User Interface illustration, showing an example of business logic flow resulting from code analysis and comprehension.

FIG. 14: A flowchart illustrating the steps to calculate a Structure Complexity score.

FIG. 15: A flowchart illustrating the steps to calculate a Dependency Complexity score.

### DESCRIPTION OF A DETAILED EXAMPLE

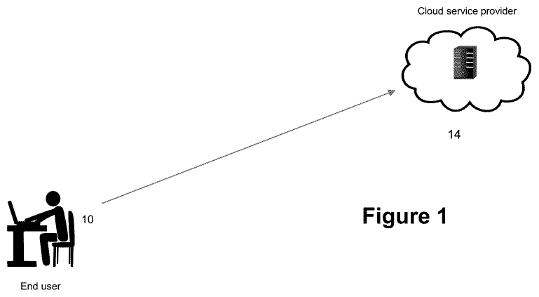

Delivering Language Learning Models (LLMs) services to users typically involves a robust and well-structured computer infrastructure, exemplified in FIG. 1's block diagram. This infrastructure is implemented as a cloud-based service in this example. Most of the LLM service functionalities are housed within the cloud, and users interact with the service through a suitable Application Programming Interface (API).

However, it's important to note that the illustrated architecture is representative and can be altered without departing from the spirit of the invention. For instance, instead of a cloud-based implementation, the LLM could be installed locally. This may be more practical and economical for large-scale users with existing IT capabilities offering sufficient computational capacity to support LLMs.

In FIG. 1, the reference numeral 10 designates an end-user that is interacting with a Generative AI system, such as a system based on a GPT architecture. The computer of the end-user 10 communicates with the cloud service provider 14 over a data network such as the Internet. Assume for the purpose of this example that the generative AI system is implemented as a utility to support a process for upgrading legacy computer code. In a specific process flow, the utility is accessible through a website hosted by the cloud service provider 14. As the user accesses the website through a browser, a Graphical User Interface (GUI) is invoked via the web browser and the user can input commands, select options and upload files through this GUI in order to enable the utility to perform the intended task.

Cloud service 14 is enabled as a series of individual cloud servers. These cloud servers not only store the vast amounts of data involved in language learning models, but they also run the complex algorithms used to analyze and learn from that data. They typically use AI Accelerators for efficient functioning of LLMs, such as GPUs (Graphics Processing Units) or TPUs (Tensor Processing Units). They greatly speed up the training and inference times of the models. Also, the cloud servers are provided with data storage systems: Given the vast quantities of data that LLMs require for training and operation, robust and secure data storage systems are used. These systems not only store the raw data and the models but also backups, logs, and other related information. Depending on the nature of the data and the regulatory environment, these may need to be localized or have specific security features.

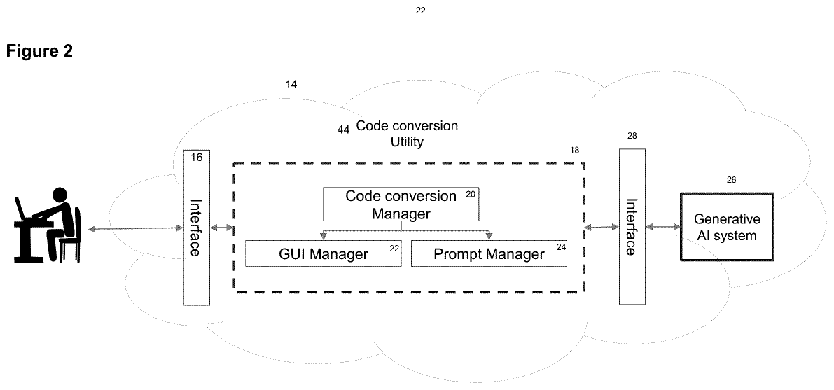

FIG. 2 provides a high-level depiction of the architecture of the cloud-based service 14, with an emphasis on the primary functional components of the utility responsible for performing software code conversion. The cloud-based service 14 encompasses an interface 16 that serves as the interaction point with the end-user 10. The end-user 10 communicates with interface 16 utilizing a web browser. It should be noted, however, that interface 16 can be deployed through alternative methods. Although a browser-based interface is generally the most practical and user-friendly solution, certain applications may necessitate alternative methods of implementation due to specific operational requirements.

A code conversion utility 18 establishes communication with the interface 16 to receive input data from the end-user and to deliver output data to the end-user via the interface 16 as a result of executing the code conversion process. The code conversion utility is implemented in software and operates on one or more central processing units (CPUs) of the servers within the cloud-based service 14. The detailed description of the hardware architecture of the cloud-based service 14 is considered redundant as it follows conventional methodologies. The inventive aspect is embodied within the software that implements the code conversion utility 18, both in its entirety and within its individual modules. The software is stored on a non-transitory medium, like any suitable data storage device, for CPU access during execution.

The code conversion utility 18 comprises a code conversion manager 20, which executes overall management and control functions for the code conversion utility 18. Specifically, the code conversion manager 20 coordinates the operation of the various modules within the code conversion utility 18 to ensure a cohesive and integrated process. The code conversion manager 20 comprises several sub-modules, each responsible for distinct aspects of the code conversion process. Each sub-module operates in tandem under the supervision of the code conversion manager 20 to facilitate the seamless conversion of legacy code to modern programming languages. These sub-modules include, but are not limited to, a GUI manager module 22 and a prompt manager module 24.

The GUI manager module 22 is responsible for implementing an interface, which constitutes a Graphical User Interface (GUI) presented to the end-user 10. This interface comprises visual controls designed to accept user inputs and present outputs, such as the results of code analysis and comprehension, suggested unit tests, and the code conversion process, to the end-user.

The interface includes two main categories of visual controls. The first category of visual controls is designed to configure a first-pass process wherein the initial computer code is processed to derive characterizing elements, such as relationships between different code elements. These visual controls allow the end-user to select the types or classes of relationships to be identified and included in the relational output. For instance, these controls may provide selectable options enabling the end-user to choose the relationships in the initial code that should be exposed. Additionally, the visual controls allow the end-user to select the characteristics of the representation of the relational output. For instance, if the relational output is a graph, the controls allow selecting the graph representation in the output, such as adjacency list, adjacency matrix, and edge list, among possible other representations.

Upon receiving user input, the first-pass process builds a relational output in accordance with the selected relationships and processes the first computer code. The resulting relational output is then displayed via the GUI, enabling the user to examine it for accuracy. Additionally, the visual controls offer tools for modifying the relational representation of the initial code. These tools include options for deleting, creating, or editing relationships within the relational representation to ensure it accurately reflects the code structure.

The second category of visual controls is generally focused on guiding the conversion of the initial computer code into the target computer code. These controls facilitate the selection of options that configure the code conversion process, such as specifying the source programming language of the initial code and the target programming language for the converted code or selecting a preferred LLM for the language and task at hand. Detailed examples of the GUI structure and functionality will be provided subsequently.

The prompt manager module 24 is configured to manage interactions with the Generative AI system 26. Specifically, the prompt manager module 24 constructs prompts based on inputs from the end-user 10 via the GUI. These prompts are then transmitted to the Generative AI system 26 to solicit a corresponding output. The prompt manager module 24 receives inputs configuring the first-pass process, such as definitions of relationships between elements of the initial computer code and the type of representation for the relational output. Upon receiving these inputs, the prompt manager module 24 constructs a prompt for submission to the Generative AI system 26 to generate the relational output.

The prompt manager module 24 comprises logic that assembles various inputs from the end-user, including the initial computer code and selectable options, to build a cohesive prompt. This prompt is then submitted to the Generative AI system 26, potentially located remotely, with communication facilitated through a suitable interface 28. The prompt manager module 24 ensures that inputs regarding the configuration of the first-pass process, such as the identification and selection of relational types and their representations, are coherently integrated into the prompt. This prompt submission enables the Generative AI system 26 to produce the desired relational output, which is then processed and displayed to the end-user via the GUI.

The output generated by the Generative AI system 26, which encompasses the relational output, is transmitted to the prompt manager module 24. The prompt manager module 24 subsequently channels this output to the GUI manager module 22, facilitating its display, review, and modification by the end-user 10 via the graphical user interface.

Upon the revision of the relational output by the end-user, the refined version is re-routed to the prompt manager module 24 for a subsequent pass processing by the Generative AI system 26. The prompt manager module 24 constructs a second prompt tailored to encompass the revised relational output, the first computer code, and additional end-user inputs.

In a specific embodiment, the constructed prompt encapsulates the refined version of the relational output, the first computer code, and the configuration inputs for the conversion process, such as the designation of the target programming language. This second prompt is then dispatched to the Generative AI system 26 to elicit an output that constitutes the second computer code in the designated target language.

In a specific example of implementation, the Generative AI system 16 includes a Large Language Model (LLM) software stack which is run by cloud servers. The software stack includes the software components such as the machine learning libraries and frameworks for building and fine-tuning LLMs, such as TensorFlow or PyTorch. Additionally, server software, databases, user interface applications, and APIs for client access are all part of the stack.

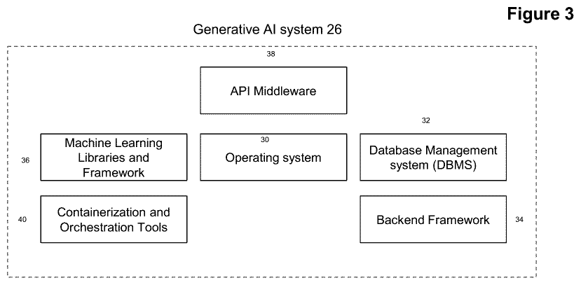

FIG. 3 illustrates in greater detail the software stack of an LLM infrastructure. As mentioned previously, the software stack is executed by one or more processors, such as CPUs and/or GPUs of cloud servers, which could be the same cloud servers as those of the cloud service provider or other cloud servers.

Typically, the service stack includes an operating system functional block 30 for the management of hardware resources and also the management of services for all the other software functional blocks. Possible choices include Linux distributions due to their stability and flexibility.

The Database Management System (DBMS) 32 interoperates with the operating system functional block 30. The DBMS 32 is responsible for managing the vast amount of data associated with LLMs, including training data, user data, and model data. Possible choices include relational databases like PostgreSQL or MySQL, and NoSQL databases like MongoDB or Cassandra, depending on the specific data needs.

The Backend Frameworks functional block 34 refers to an array of server-side frameworks that can be used to build software capable of handling the complexities associated with managing large language models. GPT-3 or GPT-4 by OpenAI are examples of large language models. Given the significant computing power and memory requirements of these models, it is useful that these frameworks offer robust performance, efficient resource management, and scalability. The key tasks they manage include handling API requests, and managing database interactions, among others. Examples of such frameworks include Node.js, Django, and Ruby on Rails.

Machine learning libraries and frameworks 36 provide pre-written code to handle typical machine learning tasks, from basic statistical analysis to complex deep learning algorithms. They help speed up the development process, make machine learning more accessible, and foster reproducible research. Here are examples of machine learning libraries and frameworks:
1. TensorFlow: An open-source library developed by the Google Brain team, TensorFlow is a popular tool for creating deep learning models. It provides a comprehensive ecosystem of tools, libraries, and community resources that facilitate the development and deployment of ML-powered applications. TensorFlow also supports distributed computing, allowing models to be trained on multi-machine setups.
2. Keras: A high-level neural networks API, capable of running on top of TensorFlow, CNTK, or Theano. It was designed to enable fast experimentation with deep neural networks. It focuses on being user-friendly, modular, and extensible.
3. PyTorch: Developed by Facebook's AI Research lab, PyTorch is a popular choice for creating dynamic neural networks in Python. PyTorch emphasizes flexibility and allows developers to work in an interactive coding environment, as opposed to the static computation graph approach of TensorFlow.
4. Scikit-learn: A Python-based library that provides simple and efficient tools for data mining and data analysis. It's built on NumPy, SciPy, and matplotlib. It provides various algorithms for classification, regression, clustering, dimensionality reduction, model selection, and preprocessing.
5. XGBoost/LightGBM/CatBoost: These are gradient boosting libraries that provide a highly efficient, flexible, and portable implementation of gradient boosting algorithms. They're commonly used for supervised learning tasks, where they have shown to be highly effective.
6. OpenCV: Open-Source Computer Vision Library (OpenCV) is a library of programming functions mainly aimed at real-time computer vision. It's used for tasks like object identification, face recognition, and extracting 3D models of objects.
7. NLTK/Spacy: These libraries are used for natural language processing in Python, which includes tasks like part-of-speech tagging, noun phrase extraction, sentiment analysis, classification, translation, and more.
8. Gensim: A robust open-source vector space modeling and topic modeling toolkit implemented in Python. It uses NumPy, SciPy, and optionally Cython for performance. Gensim is specifically designed to handle large text collections, using data streaming and incremental online algorithms, which differentiates it from most other scientific software packages that only target batch and in-memory processing.

The API Middleware functional block 38 is a software component responsible for processing client requests and responses between the web server and the application.

Containerization and Orchestration Tools 40 are used to package the application and its dependencies into a container for easier deployment and scaling. Docker is an example of a commercially available software for containerization, and Kubernetes is an example of a commercially available product used for orchestration, managing the deployment, and scaling of containers across multiple machines.

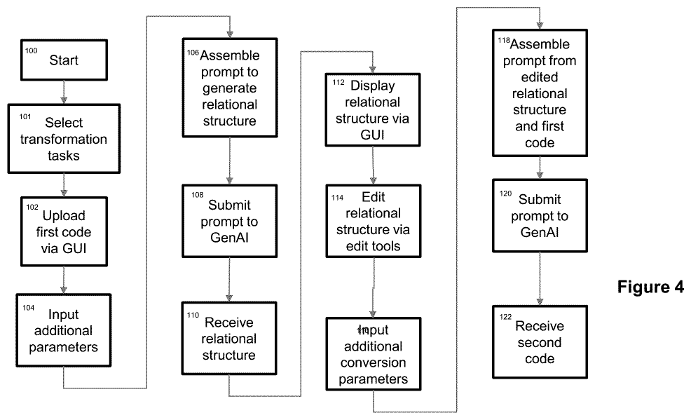

FIG. 4 illustrates a flowchart that delineates the procedural steps executed by the code analysis, comprehension, and conversion utility as described hereinabove.

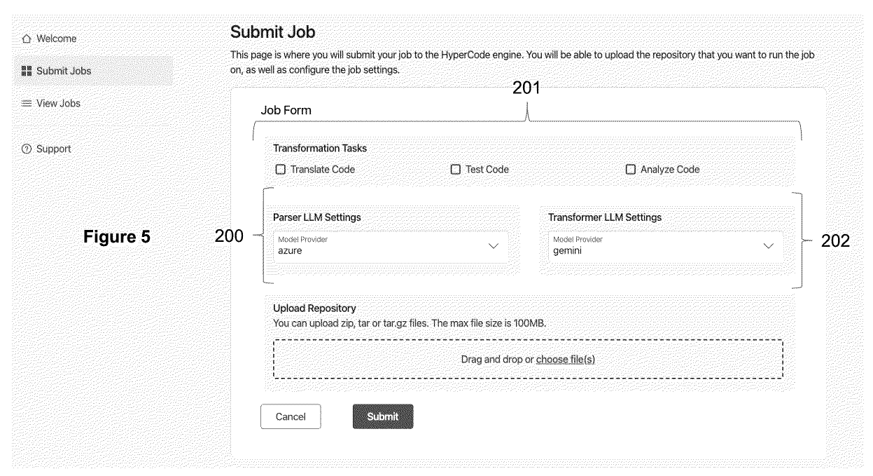

At step 100, the process is initialized, encompassing the activation of various components and preparatory actions. At step 101, the end user inputs what transformation tasks to perform out of a plurality of transformation tasks. In a specific example, an end user can choose 1 or more of the options identified in FIG. 5. In the designated control set 201, an end-user can opt to select one or more transformation tasks such as translate code, test code, and/or analyze code. At step 102, the Graphical User Interface (GUI) is invoked, prompting the end-user to input the first code. This input mechanism can be facilitated through multiple methodologies—for instance, by providing a hyperlink to a computer or network location where the code is stored, or by directly copying and pasting the code into the GUI.

At step 104, the end-user inputs additional parameters to configure the code conversion process. FIG. 5 exemplifies a GUI pane that showcases various visual controls enabling the input of the first code and specification of parameters for configuring the conversion process. Among these visual controls is a first set, designated as control set 200, which comprises drop-down menus allowing the end-user to select the Generative AI system tasked with performing a parsing process, among several Generative AI system options. The GUI pane further includes control 202, another drop-down menu enabling the end-user to select the Generative AI system tasked with performing the conversion process. The menu enumerates several LLMs, including but not limited to LLMs provided by vendors such as OpenAI, Anthropic, etc. In the illustrated example, Azure is selected as the LLM to perform the parsing process and Gemini to perform the conversion or transformer process.

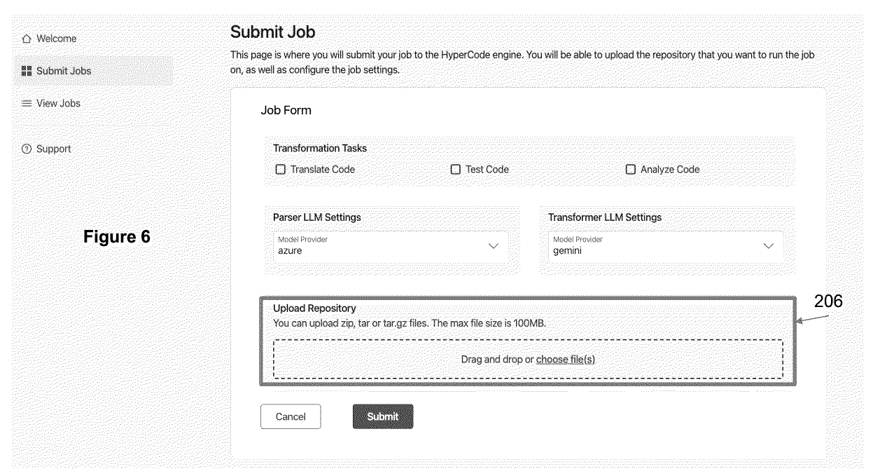

Referring now to FIG. 6, control 206 is provided for uploading the initial source code file. In this embodiment, the user uploads the file containing the initial source code via control 206.

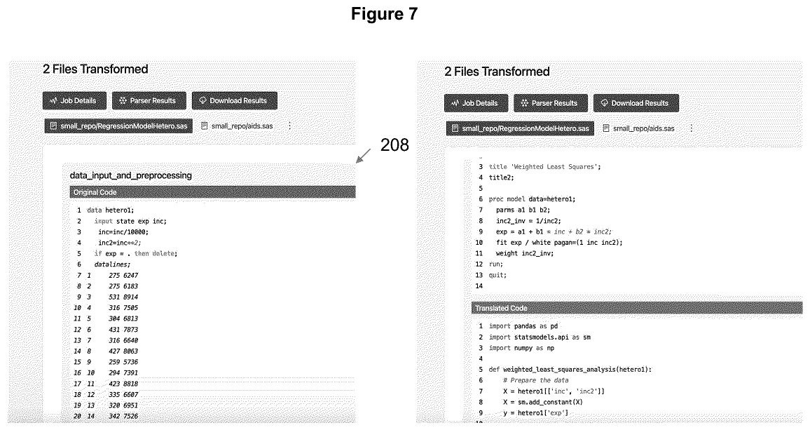

FIG. 7 illustrates the graphical user interface (GUI) pane which comprises control 208, which is a display window that presents the uploaded first software code. Additionally, while not depicted in the figures, the GUI pane may include editing tools, which enable the end-user to modify the first software code as required. These editing tools facilitate the refinement of the input code prior to initiating the conversion process.

Furthermore, the GUI pane may incorporate various supplemental controls designed to enhance user interaction and input accuracy. For instance, a control might provide options for code validation, syntax checking, or automated formatting. Such functionalities ensure that the uploaded code adheres to the required standards and is optimized for the conversion process.

While not shown in the GUI examples shown in FIGS. 5, 6, and 7, the GUI pane would also include visual controls to specify parameters specific to the generation of the relational structure, derived from the first code. Such visual controls allow the end-user to select the kind of relationships in the first code to be exposed in the relational structure. The controls also allow the end-user to configure the representation of the relational structure. The relational structure can be a graph, among other possibilities. Also, the visual control allows specifying when the graph option is selected, how the graph will be represented.

While not explicitly depicted in FIGS. 5, 6, and 7, the GUI pane is configured to encompass a plurality of additional visual controls. These controls are operatively designed to specify parameters pertinent to the generation of the relational structure derived from the first software code input. Such visual controls enable the end-user to delineate the types of relationships within the initial software code that are to be manifested in the relational structure. Additionally, these controls facilitate the configuration of the representation modalities of the relational structure. The relational structure may assume various forms, including but not limited to, a graph. Furthermore, when the graph representation option is selected, the visual controls permit the end-user to specify the parameters that dictate the graphical depiction of the relational structure, thereby optimizing the clarity and utility of the generated output.

An example of a visual control could be the ability to select the preferred granularity of relational structure and elements to be presented. Options could include 1. Fine-Grained Elements (i.e., Variables, Constants, Parameters, and Data Structure Components), 2. Code-Level Constructs (i.e., Snippets/Blocks, Functions, Classes/Objects, Threads/Processes), 3. Intermediate Components (i.e., Tests cases, APIs/Interfaces, Resources, Constraints), 4. Structural Components (i.e., Modules, Packages, Libraries, Dependencies, Code Files), and 5. Abstract Features (i.e., Features, Events, Version Control Elements, Errors). This facilitates a better understanding of relationship across levels where fine-grained elements are often used or referenced by code-level constructs, and code-level construct are organized into structural components and, structural components contribute to implementing abstract features of the system. For example, a variable might be used in a function, which is a part of a class, stored in a module, and contributes to a high-level feature like “user authentication”. The ability to optionally visualize hierarchy provides clarity for system analysis, debugging, optimization, and documentation. It also helps determine the appropriate level of abstraction for modeling relationships, such as deciding whether to use a graph, hypergraph, or another relational structure representation.

Referring back to FIG. 4, particularly to step 106, the input provided by the end-user via the graphical user interface (GUI) is transmitted to the prompt manager 24, which constructs a prompt for soliciting the Generative AI system to generate the relational structure. The initial software code is incorporated into the prompt along with specific directives instructing the Generative AI system to generate the relational structure.

The embedding of the software code into the prompt can be executed through various methodologies. One such methodology involves directly embedding the code within the text of the prompt. Another methodology entails inserting a hyperlink within the prompt that directs to a computer or network location where the initial software code is stored, thereby allowing it to be downloaded and utilized by the Generative AI system.

An exemplary prompt, specifically the directives for parsing source code and generating a relational structure, is illustrated below:

### Example Prompt

“You are a code parsing assistant with expert knowledge in several different programming languages. Your job is to break up a piece of source code into logical sections (e.g. variable declarations, library imports, function definitions, etc.) in which similar functionalities are grouped together. Do this for each file from the provided code base and ensure to delineate the interdependencies and interactions between the various components. The relational structure should encompass all defined relationships and be represented in a graphical format.”

At step 108, the prompt manager then transmits this assembled prompt to the Generative AI system, initiating the process of generating the relational structure. This system processes the embedded software code as per the provided instructions, producing a detailed relational structure which is subsequently presented to the end-user via the GUI for further analysis and refinement at step 112.

Optionally, at step 114, the end-user has the capability to review and edit the generated relational structure. Such edits may encompass the addition, deletion, or modification of relationships. This operation yields an edited relational structure which, together with the input of additional parameters at step 116, is forwarded to the prompt manager 24. The prompt manager subsequently constructs a further prompt for executing the second step process, which involves embedding in the prompt the edited relational structure along with the first software code, unless the code is retained in the conversation memory of the Generative AI system. This prompt is then transmitted to the Generative AI system at step 120, and the converted code in the target software language is received at step 122.

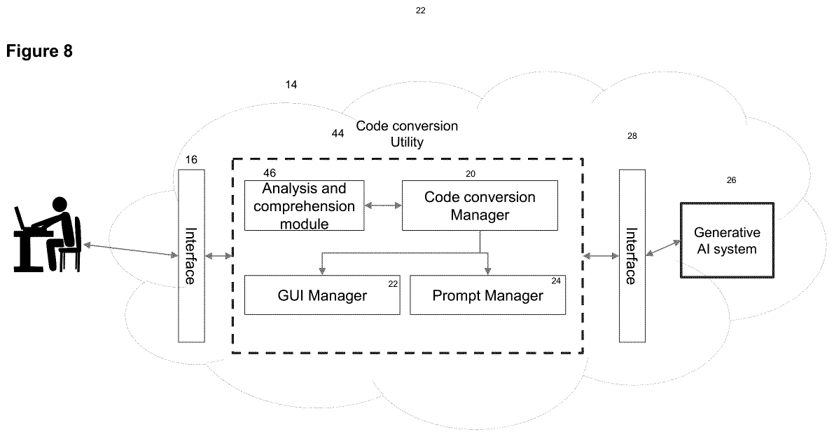

FIG. 8 provides an illustration of an alternative embodiment of the code conversion utility previously depicted in FIG. 2. This alternative embodiment, designated as code conversion utility 44, incorporates an additional analysis and comprehension module 46. The primary function of this analysis module is to perform a code analysis and comprehension on certain elements, or potentially all elements, of the data flow within the code conversion utility 44. The objective of this analysis is to provide useful insights and metrics related to the provided source code and to enhance the performance efficiency of the conversion process, as it is described below.

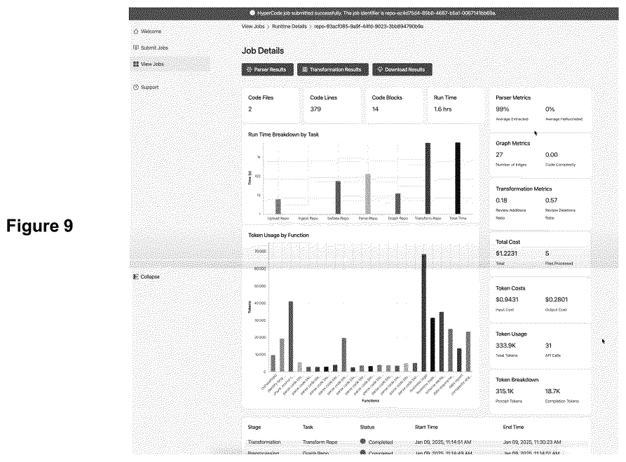

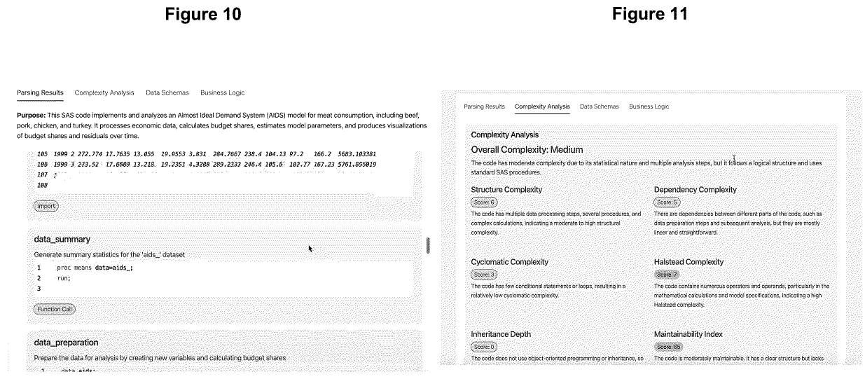

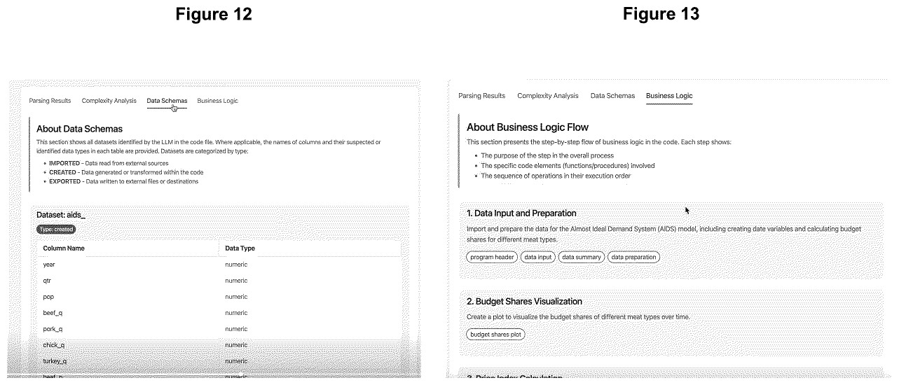

The analysis and comprehension module 46 implements logic, which includes an input configured to receive data to be analyzed. This data input can originate from a variety of sources, including but not limited to end-user inputs, data received from a Generative AI system, or data generated internally within the code conversion utility 44 itself. Upon receiving the data, the logic parses the source code and processes it to generate insightful information as shown in FIG. 9 through 13, which provide illustrations of the output of parsed results, complexity analysis, data schemes, and business logic.

FIGS. 9 through 13 provide illustrations of the various type of results presented based on data provided by the analysis and comprehension module. This data, after being analyzed by the analysis and comprehension module 46, is typically presented to the end-user through a GUI. The insights provided by the analysis and comprehension module 46 are designed to inform the user about various aspects of the source code and conversion process, encompassing both historical data and predictive insights. These aspects may report on processing steps already undertaken or forecast future processing events. Such insights are intended to guide the end-user in selecting options that could optimize or improve the overall process.

These optimized adjustments can be particularly beneficial in refining the inputs fed into the conversion utility, thereby enhancing the efficiency and accuracy of the conversion process.

In a specific example of implementation, the analysis and comprehension module 46 is configured to estimate the token volume, more specifically the input token volume and/or the output token volume.

The process of approximating tokens for input and output processing in Generative AI systems is pertinent to the efficiency and cost-effectiveness of these systems. Typically, Generative AI systems, particularly those using serverless LLMs, are priced based on token consumption during both input and output phases. It should be noted that the information-to-token ratio in code is higher compared to natural language, making efficient handling of tokens an important economic factor.

The code conversion process often involves multi-pass token consumption, especially in the context of code analysis and comprehension. This entails multiple iterations over the same set of tokens to ensure comprehensive parsing and analysis. Therefore, there is a token overhead associated with maintaining cross-module code context, which is essential for preserving the integrity and coherence of the entire codebase.

Additionally, the token requirements in parsing nested and referential code structures are non-linear. This complexity demands a sophisticated approach to token management, ensuring every aspect of the code is thoroughly examined without unnecessary token expenditure. Different programming languages exhibit varying token densities, and this variability may be accounted for to optimize token usage effectively.

In code-to-text conversions, tokens are utilized in a complex manner. The precision required in such conversions implies that a higher token allocation is necessary to achieve the desired accuracy. The construction of code relationship relational structures, which delineate the interdependencies and interactions between various components, also incurs a significant token cost.

Furthermore, task-specific LLM agents engaged in coding tasks display unique token patterns. These patterns are tailored to the specific requirements of the task, ensuring that the LLM operates with maximum efficiency and effectiveness. The primary goal is to balance token consumption with the accuracy and reliability of code analysis and conversion processes, thereby enhancing overall system performance.

In summary, the management of tokens in serverless LLMs is a crucial factor in optimizing both cost and performance. By addressing the intricacies of token usage in code analysis, cross-module context maintenance, and code-to-text conversions, it is possible to achieve higher levels of efficiency and accuracy, ultimately benefiting the end-users of these advanced computational models.

In a first example of implementation, the analysis and comprehension module 46 makes an estimation of the input token count and also makes an estimation of the output token count. The process for making the input token count estimate and the output token count estimate uses the following formula:

$${T}_{total} = \frac{Input processing tokens}{( {L}_{input \_ source \_ code} \times 10 )} + \frac{Output creation tokens}{( {L}_{input \_ source \_ code} \times 2 )} + \frac{Use case tokens}{( {N}_{use \_ cases} \times 1000 )}$$

Firstly, the total lines of code are counted, and this figure is multiplied by a predetermined average number of tokens per line, for example, 10 tokens per line. That number can vary according to the specific language. This initial calculation provides a baseline estimate for the input tokens.

Subsequently, the output tokens are estimated on the basis of the estimate for the input tokens, for example by applying a multiplication factor to the input tokens. For instance, the input token count may be multiplied by a factor of 2 or another number, to account for the complexity and additional processing required during the output phase.

Furthermore, a constant number of tokens, such as 1000 tokens, is optionally added for each use case being processed. This addition accounts for the overhead and auxiliary token consumption associated with specific tasks and scenarios.

The method also employs a single, fixed complexity factor for all codebases, irrespective of their actual complexity. This consistent factor simplifies the estimation process, ensuring uniformity across diverse codebases.

Additionally, the estimation assumes that all programming languages and tasks necessitate the same token density. This assumption standardizes the token estimation process, disregarding the inherent differences in token distribution among various languages and tasks.

The method applies a linear scaling of token usage with the size of the codebase for all operations. This linear approach facilitates straightforward scalability and adaptability to different codebase sizes.

The same token estimation methodology is utilized for all types of analysis and generation tasks. This uniform approach ensures consistency and reliability in token management across various functions.

Moreover, the method disregards differences in verbosity between source and target languages during transpilation. Transpilation is a combined process which performs transformation and compilation functions. This simplification focuses on token count rather than linguistic nuances, streamlining the estimation process.

A fixed token overhead is assumed for large language model agents and hypergraph operations. This fixed overhead ensures that the token requirements for these advanced computational processes are adequately covered.

Lastly, the method does not account for the need for context retention and efficient prompt engineering in large language models (LLMs). This approach highlights the primary focus on token count estimation rather than optimizing prompt and context management.

In a preferred example, the process for estimating the input and the output tokens takes into account additional factors to provide a more accurate token estimate, namely more accurate estimate of the input tokens, output tokens and advantageously both.

### Formula for Approximating Input Tokens

Baseline processing tokens required to analyze the base source code, which includes initial comprehension and setup operations that are common across all use cases.

Additional tokens needed for processing each specific use case because each use case may involve distinct operations on the base code, adding to the total input tokens required.

$${T}_{input} = ( {L}_{code} \times {T}_{density} \times {C}_{code} ) + {\sum }_{i = 1}^{{N}_{use \_ case}} ( {S}_{usecase} \times {L}_{code} \times {T}_{density} \times {C}_{code} )$$

L_{code}=Length of base source code (in lines)
T_{density}=Average token density per line of base source code
C_{code}=Average complexity factor of base source code (range: ≥1)
S_{usecase}=Processing scope of base source code for specific use case (range: ≥0.01)

### Formula for Approximating Complexity of Base Source Code

$${C}_{c o d e} = ( {α}_{1} \times S ) + ( {α}_{2} \times D ) + ( {α}_{3} \times CC ) + ( {α}_{4} \times H ) + ( {α}_{5} \times I ) + ( {α}_{6} \times M ) + ( {α}_{7} \times A C )$$

αₙ=Weighting coefficients that can be tuned based on empirical data or specific project requirements.

These coefficients determine the relative importance of each factor in the overall complexity calculation. Each weighting coefficient must have a value between 0 and 1 with all weighting coefficients summing to 1.
S=Structure complexity score
D=Dependency complexity score
CC=Cyclomatic complexity score
H=Halstead complexity score/=
I=Inheritance depth score
M=Maintainability index
TD=Technical Debt score

### Formula for Approximating Output Tokens

Accounting for the output tokens specifically required for transpiling code, using the complexity and token density of the target programming language.

Sum of the output tokens across all chosen use cases, considering the expected output length and token density for each.

$${T}_{output} = ( {B}_{transpilation} \times {L}_{code} \times {C}_{output \_ density} ) + {\sum }_{i = 1}^{{N}_{use \_ case}} ( {L}_{output} \times {T}_{output \_ density} )$$

Lₒᵤₜₚᵤₜ=Expected length of the output text for each use case (in lines)
T_{output_density}=Average token density per line of output text for each use case (tokens per line)
Bₜᵣₐₙₛₚᵢₜₐₜᵢₒₙ=Semaphore tag that is 1 if transpilation is one of the use cases, otherwise 0
L_{code}=Expected length of the output code only for transpilation use case (in lines)
C_{output density}=Average token density for each line of code in the target programming language.

A preferred method for estimating token usage is discussed below. The preferred method incorporates various additional factors to enhance the accuracy of the token estimate.

Firstly, the preferred approach now takes into account the differential token densities inherent in various programming languages. By recognizing these disparities, the method can provide a more tailored and precise token estimation for multilingual codebases. In terms of implementation, the analysis and comprehension module 46 has a table or any other data structure mapping different programming languages to respective token density factors. In terms of specific steps, once the first software code is uploaded and the programming language of the first software code is classified by the LLM being used in the system, the analysis and comprehension module 46 references this table to extract the token density factor that is associated with the programming language of the first software code, and then uses this token density factor into the calculations.

Optionally, the approach considers the varying verbosity levels of input and output across different use cases. For example, the token requirements for tasks such as transpilation differ significantly from those for requirement extraction. By accommodating these differences, the estimation process becomes more robust and reliable. From the perspective of implementation of the process, the analysis and comprehension module 46 maps tasks to verbosity level factors and uses the relevant verbosity level factors depending on the specific tasks performed during the code conversion process.

Optionally, the method also integrates an overhead factor associated with constructing and manipulating high-dimensional relational structures, such as hypergraphs. This inclusion ensures that the token consumption for advanced computational processes is better accounted for, reflecting the complexity of the operations involved. The overhead factor can be a constant or a variable. In the case of a variable, the overhead factor can be made dependent on the dimension or complexity of the relational structure, such that relational structures of higher complexity are assigned a larger overhead factor.

Optionally, the refined formula accounts for the impact of code structure and interdependencies on token consumption. By considering these structural factors, the methodology can better estimate the tokens required for analyzing interconnected code segments.

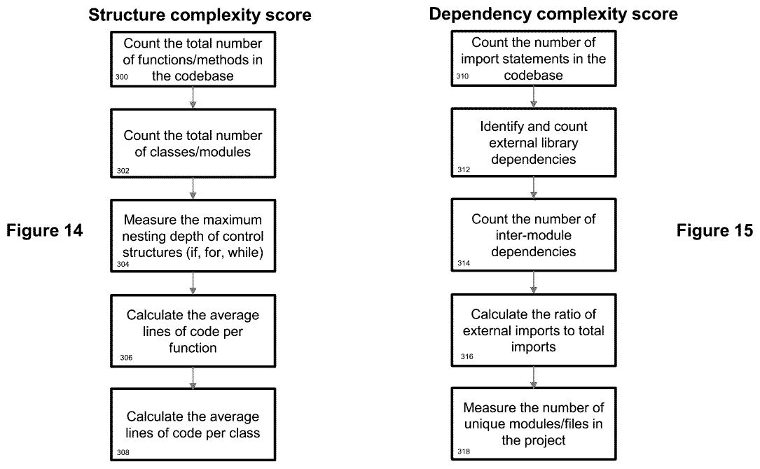

FIG. 14 is a flowchart outlining the steps to calculate a Structure Complexity score and similarly FIG. 15 outlining the steps to calculate Dependency Complexity score. These scores are then used in the provided formula for approximating “Complexity” of the base source code, which is then used in the formula provided for approximating input tokens.

Optionally, the approach takes into consideration the context retention requirements across multiple interrelated analyses. This factor is crucial for ensuring that the token estimate accurately reflects the need for maintaining contextual coherence in complex scenarios. Context is a variable because it needs to be interpreted for each block and for each task at hand. For example, to transpile or test a single block of code, we may need to also find other outgoing and incoming invocations to other blocks in the code base. The lookup process is based on the hypergraph, from which a query on the graph will return the context which can be varied in length, thereby changing the token consumption.

The refined token estimation process also optionally captures the non-linear scaling of token usage in intricate code analyses. This aspect is particularly relevant for large-scale projects where token consumption does not increase linearly with code size. This is an observation indicating that for more complex code the token usage is a not a function of the code base size. For complex code, an understanding of the interdependencies of code blocks need to be taken into consideration when performing tasks such as transpilation. In this specific example this means that more context (i.e., tokens) need to be used in each iteration, thereby increasing the total token consumption.

Optionally, the methodology incorporates the iterative nature of processes such as test generation and code scoring. By reflecting the repetitive steps involved, the token estimate becomes more comprehensive and accurate. This is also an observation, where is a specific example in order to automatically generate test scripts for a block of code, an understanding of any incoming or outgoing invocation calls to other blocks of code in the code base needs to be established by querying the hypergraph, which retrieves code blocks that are required for a full understanding of the context of the block in question by the LLM. This query is a dynamic lookup and therefore can 1) optimize our token consumption by only retrieving what is needed to understand the context (rather than the entire class/file), and 2) calculate the length of the context as part of the overall token consumption.

Optionally, the approach also addresses the varying complexity of different analysis types, such as security audits versus schema extraction. This differentiation ensures that each type of analysis is allocated an appropriate token estimate based on its specific demands. In a specific example related to a static security analysis of source code, one pass may be required as you look at the implementation, whereas to infer a data schema as its being processed in the code may require multiple passes and/or requiring access to a wider context window. This window length is of interest when estimating related token allocations.

Optionally, the method further accounts for the token costs associated with translating between code and natural language representations. This factor is essential for tasks that involve bidirectional translations, ensuring that both source and target languages are adequately supported. A hypergraph lookup will retrieve the context in source code, and then instruct the LLM to generate a response in a specific format and within a token limit. In a specific example a data lineage report is generated in English explaining what datasets are used within a single file and how the records and their attributes were modified throughout the business logic implemented in the file.

Optionally, the formula reflects the dynamic token allocation needs of specialized large language model (LLM) agents for diverse tasks. This consideration ensures that the token requirements for deploying advanced LLM agents are accurately captured, enhancing the overall efficiency and effectiveness of the token estimation process.

In a further embodiment token approximation is a significant factor in selecting an appropriate LLM for distinct use cases (i.e., complexity, language, etc.) based on user inputs that characterize the request or prompt from which a selector mechanism is able to make a more sophisticated decision. More specifically, a computer implemented selector mechanism configured to select a Generative AI entity among a plurality of Generative AI entities, and to optionally route a user request to the selected Generative AI entity for processing and output generation. Optionally, the integration of a dynamic feedback mechanism, enabling continuous learning and adaptation of the selector mechanism based on operational performance and user satisfaction metrics, thereby progressively enhancing the efficacy and precision of the Generative AI entity selection process over time.

1. A computer system comprising one or computers and one or more data storage devices storing instructions, which when executed by the one or more computers implements a computer code conversion utility, comprising:
a. a Graphical User Interface (GUI) manager;
b. a prompt manager;
c. a Generative AI service interface;
d. the GUI manager being configured to implement a GUI for receiving an input, including a first computer code;
e. the prompt manager configured to generate in response to the input a first Generative AI service prompt with instructions to derive from the first computer code a relational representation of the first computer code;
f. the prompt manager configured to generate a second Generative AI service prompt conveying the relational representation or a derivative form of the relational representation and the first computer code with instructions to convert the first computer code to a second computer code where the second computer code retains an overall functionality of the first computer code; and
g. the Generative AI service interface configured to receive the second computer code.

2. A computer system as defined in claim 1, wherein the first computer code is in a first language and the second computer code is in a second language different from the first language.

3. A computer system as defined in claim 2 wherein the relational representation is in the form of a graph, comprising nodes and edges.

4. A computer system as defined in claim 2, wherein the GUI manager is configured to implement on the GUI controls to configure a processing of the first computer code to generate the second computer code.

5. A computer system as defined in claim 4, wherein the relational representation captures semantic associations between different components of the first code.

6. A computer system as defined in claim 5, wherein the different components of the first code include either one of the following: functions, variables, classes, methods, modules and libraries.

7. A computer system as defined in claim 4, wherein the GUI manager being configured to display on the GUI the relational representation.

8. A computer system as defined in claim 7, wherein the GUI manager being configured to implement tools allowing a user to modify the relational representation and generate a derivative form of the relational representation.

9. A computer system as defined in claim 6, wherein the controls to configure the processing of the first code include a control to configure the processing of the first code to generate the relational representation.

10. A computer system as defined in claim 9, wherein the control to configure the processing of the first code to generate the relational representation is configured to allow a user to select components of the first code to be included in the relational representation.

11. A computer system as defined in claim 9, wherein the controls to configure the processing of the first code include a control to specify the language of the first code.

12. A computer system as defined in claim 11, wherein the controls to configure the processing of the first code include a control to specify the language of the second code.

13. A computer system as defined in claim 12, wherein the prompt manager being response to user input at the control to specify the language of the second code to generate instructions in the second prompt directing the Generative AI service to output the second code in the specified language.

14. A computer system as defined in claim 11, wherein the prompt manager is response to user input at the control to specify the language of the first code to generate instructions to the Generative AI service to indicate the specified language of the first code.

15. A computer system as defined in claim 1, wherein the GUI manager is responsive to the second computer code received via the Generative AI service interface to display the second computer code via the GUI.

16. A computer-readable storage medium encoded with non-transitory machine instructions which when executed by a data processor implements a computer code conversion utility, comprising:
a. a Graphical User Interface (GUI) manager;
b. a prompt manager;
c. a Generative AI service interface;
d. the GUI manager being configured to implement a GUI to receive an input including a first computer code;
e. the prompt manager being responsive to the input to generate a first Generative AI service prompt with instructions to derive from the first computer code a relational representation of the first computer code;
f. the prompt manager configured to generate a second Generative AI service prompt conveying the relational representation or a derivative form of the relational representation and the first computer code with instructions to convert the first computer code to a second computer code where the second computer code retains an overall functionality of the first computer code;
g. the Generative AI service interface configured to receive the second computer code.

17. A computer-readable storage medium as defined in claim 16, wherein the first computer code is in a first language and the second computer code is in a second language different from the first language.

18. A computer-readable storage medium as defined in claim 17 wherein the relational representation is in the form of a graph, comprising nodes and edges.

19. A computer-readable storage medium as defined in claim 17, wherein the GUI manager is configured to implement a GUI comprising controls to configure a processing of the first computer code to generate the second computer code.

20. A computer-readable storage medium as defined in claim 18, wherein the relational representation captures semantic associations between different components of the first code.
